(19) United States
(12) Patent Application Publication
(10) Pub. No.: US 2014/0292218 A1
(43) Pub. Date: Oct. 2, 2014

(54) TRANSISTOR LED LADDER DRIVER WITH CURRENT REGULATION AND OPTICAL FEEDBACK FOR LIGHT EMITTING DIODES

(71) Applicant: 3M INNOVATIVE PROPERTIES COMPANY, St. Paul, MN (US)

(72) Inventor: Martin J. Vos, St. Paul, MN (US)

(21) Appl. No.: 14/353,560

(22) PCT Filed: Dec. 11, 2012
(86) PCT No.: PCT/US12/68927

§ 371 Date: Apr. 23, 2014

Related U.S. Application Data
(60) Provisional application No. 61/570,995, filed on Dec. 15, 2011.

(51) Int. Cl. H05B 33/08

(52) U.S. Cl. CPC H05B 33/0842
USPC 315/193

(57) ABSTRACT

Ladder network circuits (100) for controlling operation of light emitting diodes (LEDS, 110) using current regulation. The circuits include a number of light sections (110) connected in series and a current regulation circuit (130) configured to limit a LED current flowing through the plurality of light sections (110).

### BACKGROUND

Light emitting diodes (LEDs) typically have low forward drive voltages and can be driven by a DC power supply. For example, LEDs in a cellular phone are powered by a battery. A string of multiple LEDs in series can also be directly AC driven from a standard AC line power source. For example, Christmas tree LED lights are a string of LEDs connected in series so that the forward voltage on each LED falls within an acceptable voltage range. Alternatively, a string of LEDs can be driven by a DC power source, which requires conversion electronics to convert a standard AC power source into DC current.

### SUMMARY

At least one aspect of the present disclosure features a circuit for controlling operation of light emitting diodes (LEDs), comprising a plurality of light sections connected in series and a current regulating circuit coupled to the plurality of light sections. The light sections being configured for connection to an AC power source, wherein each light section comprises an LED and a switch circuit coupled to the LED and configured to activate the LED. At least two light sections are activated in sequence in response to power supplied from the AC power source. The current regulating circuit is configured to limit a LED current flowing through the plurality of light sections based upon the number of activated light sections.

At least one aspect of the present disclosure features a circuit for controlling operation of a string of light emitting diodes (LEDs), comprising a first section and a second section connected in series, the sections being configured for connection to a power source. Each section comprises at least one LED, an optical sensor coupled to the at least one LED and configured to output a signal indicative of the optical output of the at least one LED, and a switch circuit coupled to the at least one LED. The switch circuit activates the at least one LED and controls current through the at least one LED. The first section is activated before the second section in response to power supplied from the power source. The switch circuit of the first section turns off if the signal output by the optical sensor of the second section reaches a predetermined threshold.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of a LED transistor ladder driver with current regulation;

FIG. 2A is an illustrative circuit diagram of an exemplary LED transistor ladder driver with current regulation;

FIG. 2B is another exemplary circuit diagram of a LED transistor ladder driver circuit;

FIG. 2C illustrates yet another exemplary circuit diagram of a LED transistor ladder driver circuit;

FIG. 3A is a graph of approximating the gate-source voltage versus drain current characteristic for a depletion mode transistor;

FIG. 3B illustrates a graph of resistor ratio Wₙ/Bₙ versus light section number;

FIG. 4 is a block diagram of an exemplary LED transistor ladder driver with optical sensing;

FIG. 5 is an illustrative circuit diagram of an exemplary LED transistor ladder driver with optical sensing;

FIGS. 6A and 6B illustrate exemplary optical sensing circuit diagrams for the gate control of the Gₙ of the light section n;

FIG. 7 is a graph illustrating power factor performance of an 11 section LED ladder driver; and

FIG. 8 is a graph illustrating a current spectrum of a LED ladder driver having harmonic distortion within the IEC limits.

### DETAILED DESCRIPTION

A plurality of light emitting diodes (LEDs) in series can be directly AC driven from a standard AC line power source. Directly AC driven LEDs in series, however, often exhibit significant harmonic distortion, which is undesirable. Also, the dimming capability is compromised. Therefore, a modification or improvement is desirable to allow a sufficient current flow for low drive voltages with minimum harmonic distortion and near unity power factor resulting in an implementation allowing dimming capability, particularly as LED lights replace incandescent and fluorescent lamps.

The present disclosure is directed to embodiments of LED driver circuits allowing driving multiple LEDs in series in AC line applications with minimal harmonic distortion in drive current and near unity power factor. The driver circuits are designed to be converted to integrated circuits (ICs) such that the costs of the circuits are reduced for large quantity manufacturing. In some embodiments, the driver circuits do not have inductor and capacitor elements that are not feasible components to be fabricated onto an IC chip. In some other embodiments, the driving circuits comprise only fixed value components, such as fixed value resistors, which reduce manufacturing complexity and cost. The circuits also allow direct dimming as well as color variation with a dimmer circuit, for example, a conventional TRIAC dimmer. Furthermore, the circuitry has line voltage surge protection capability and a relative insensitivity to undervoltage operation. Such circuits can provide the benefits of high efficiency and low cost.

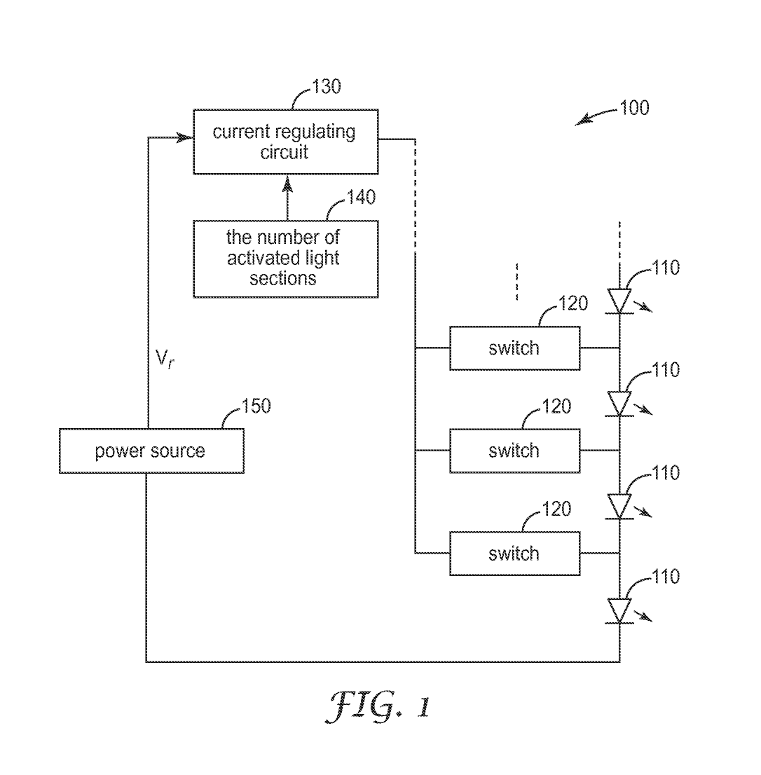

FIG. 1 is a block diagram of an exemplary LED transistor ladder driver with current regulation 100. In some embodiments, a plurality of light sections are connected in series and configured to connect to a power source, such as an AC power source. The transistor ladder driver 100 includes a power source 150, a current regulating circuit 130, and for each light section includes an LED device 110 and a switch circuit 120 (typically not included in the highest light section). The number of activated light sections 140 is an optional component that can provide input to the current regulating circuit 130. The light sections are activated in sequence from low to high (i.e., from Light Section 1 to Light Section N). The LED device 110, also referred to as a ‘LED’, comprises one or more LED junctions, where each LED junction can be implemented with any type of LED of any color emission but with preferably the same current rating. In some embodiments, the LED junctions are connected in series. Multiple LED junctions can be contained in a single LED housing or among several LED housings. For example, the LED device 110 may comprise six LED junctions within one LED housing.

The switch circuit 120 is normally closed or conducting. When the power source 150 increases its output Vᵣ over a predetermined threshold, the switch circuit 120 of a light section n is opened or non-conducting. The switch circuits of lower light sections i (i<n) are opened or non-conducting. In such implementation a LED current flows through the LEDs in the light sections from the first light section to the light section n+1 and these LEDs become illuminated. The predetermined threshold can be determined by the switch circuit design. The switch circuit 120 may include one or more transistors. In some implementations, the switch circuit 120 may include a depletion mode transistor. The switch circuit 120 may include one or more resistive elements, for example, such as resistors. In some implementations, the switch circuit 120 may include a variable resistive element, which can be adjusted to fine tune the predetermined threshold relative to the output Vᵣ of the power source 150. The current regulating circuit 130 is configured to limit the LED current based upon the number of activated light sections 140. The current regulating circuit 130 may include a depletion mode transistor, a MOSFET, a high power MOSFET, or other components.

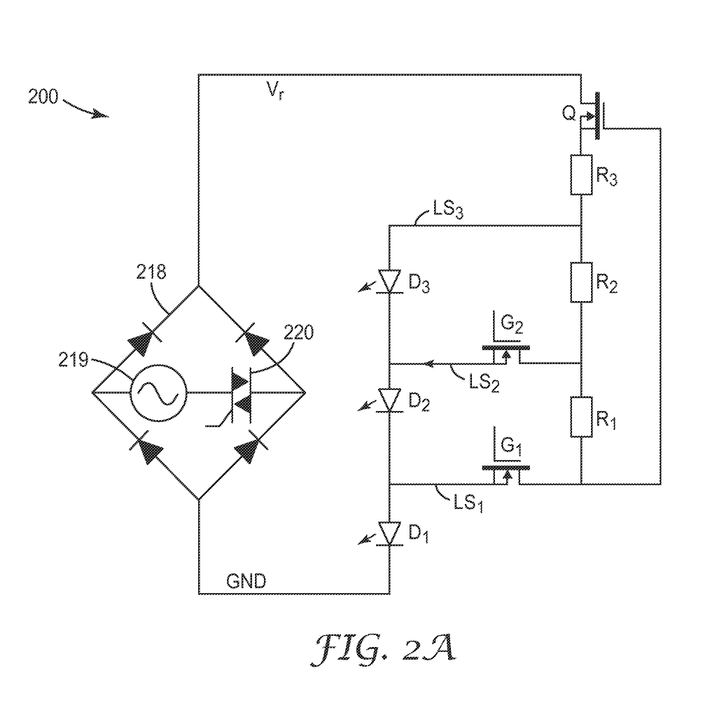

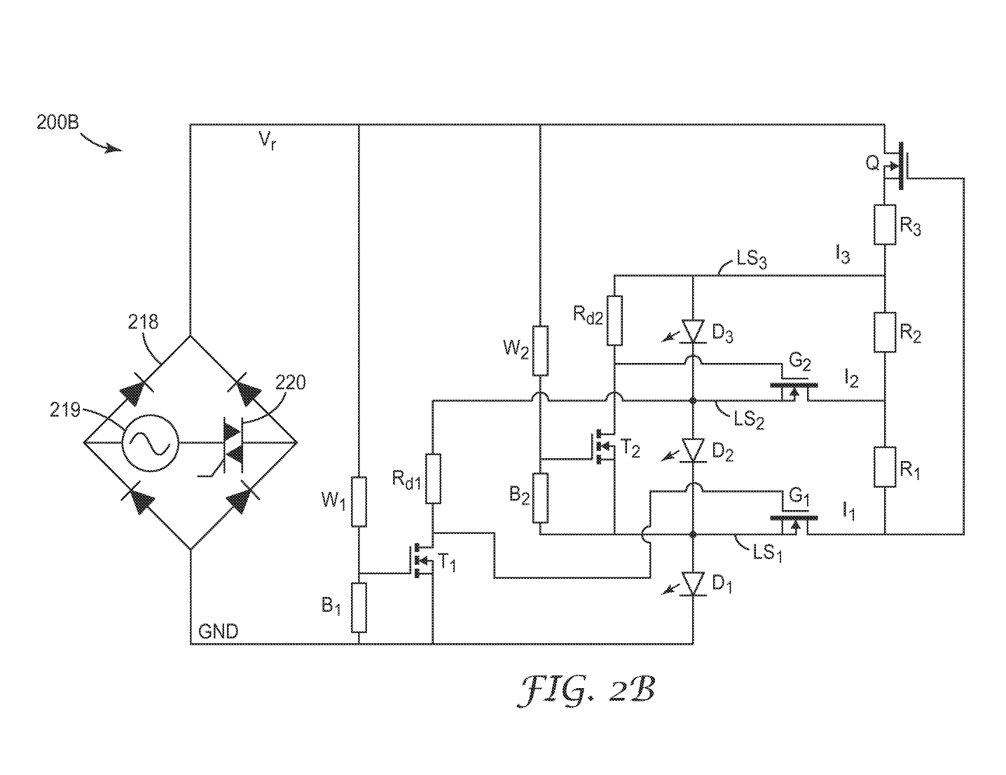

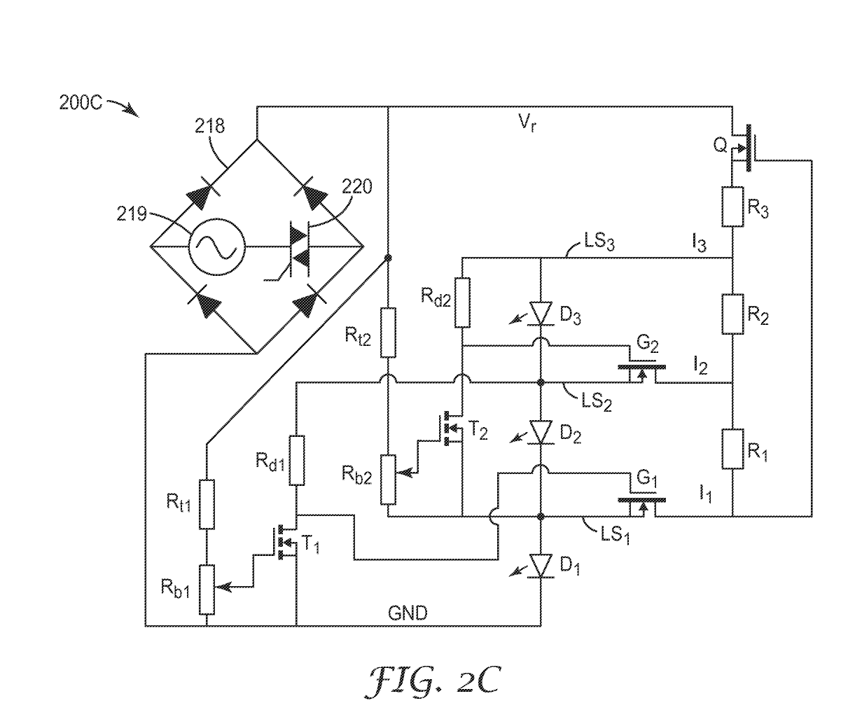

FIG. 2A is an illustrative circuit diagram of an exemplary LED transistor ladder driver with current regulation 200 for driving a plurality of LEDs connected in series. Circuit 200 includes a series of three (N=3) light sections LS₁, LS₂, and LS₃ connected in series and a depletion mode transistor Q for regulating LED current. Each light section n(1≦n≦N) controls Lₙ LED junctions. The first section LS₁ includes LED junctions D₁ depicted as one diode, a resistor R₁, and a transistor G₁ functioning as a switch. The second section LS₂ includes LED junctions D₂ depicted as one diode, a resistor R₂, and a transistor G₂. The third section LS₃ includes LED junctions D₃ depicted as one diode and a resistor R₃. In some implementations, when a light section n is activated, a large negative gate-source voltage for G transistors in the lower light sections (i.e., light sections i, where i<n) can be obtained such that cut-off is more effective by properly biasing the gate voltage of the G transistors in these lower light sections. As used herein, cut-off refers to G transistors having relatively low drain source current such that the G transistors function close to a switch. In some implementations, the G transistors can have negligible drain source current such that the G transistors function close to a perfect switch (i.e., with open state with current as OA). In such implementations, the highest light section does not have a G transistor as it typically will not be cut off. Switch transistors G₁ and G₂ can each be implemented by a depletion MOSFET, for example a BSP149 or an IXTA6N50D2 MOSFET. Current limiting transistor Q can also be implemented by a depletion MOSFET, for example an IXTA6N50D2 MOSFET. The light sections form a ladder network in order to activate the LEDs in sequence from the first section (LS₁) to the last section (LS₃) in FIG. 2A.

The light sections LS₁, LS₂, and LS₃ are connected to a rectifier 218 including an AC power source 219 and a dimmer circuit 220. In FIG. 2A, the dimmer circuit 220 is depicted as a TRIAC but can also be based on other line phase cutting electronics. In a practical 120 VAC case there are preferably more than three sections, possibly eight to sixteen sections to bring the section voltage into a range of 10 to 20 volt.

In FIG. 2A, only three light sections are shown, but the ladder can be extended to any N light sections with a number of Lₙ LED junctions for each light section n that is consistent with the maximum Vᵣ drive voltage where the total number of LED junctions is given by the summation of

$${\sum }_{n = 1}^{N} {L}_{n} .$$

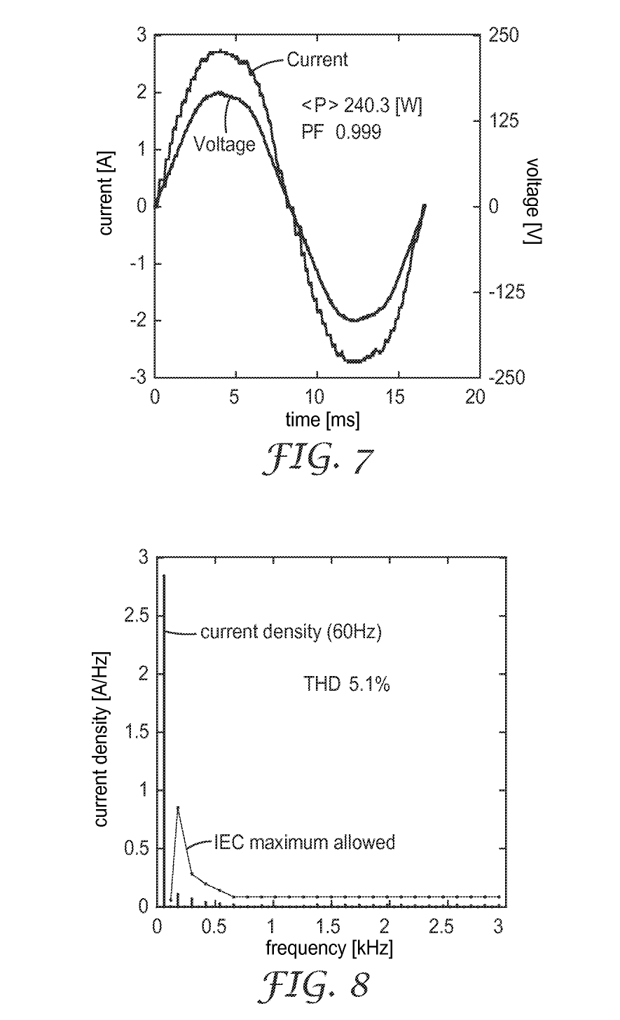

Also, each light section can contain more than one LED junction. In some cases, each light section contains at least three LED junctions. Multiple LED junctions can be contained in a single LED component or among several LED components. The transistor Q limits the LED current flowing through the light sections. These current limits are visible as small plateaus in FIG. 7. The Q transistor usually does not require a high voltage rating. Its gate-source voltage is typically limited because for higher Vᵣ values more light sections will become currentless resulting in no voltage drop over the lower Rₙ resistors.

During extreme line power consumption, an undervoltage situation can occur that may lead to one or more upper LED sections not being illuminated. The other sections however remain illuminated at their rated currents so that undervoltage situations have a limited effect on the total light output.

With <P> the time averaged consumed power in a 120 Vᵣₘₛ line voltage system, the maximum or peak line current Iₘₐₓ is approximately given by:

$${I}_{max} \approx \frac{\sqrt{2} < P >}{120} \qquad ( 1 )$$

In the FIG. 2A arrangement, the light section current limit Iₙ is determined by that Q gate-source voltage V_{GS} imposing Iₙ through feedback with the sum of resistors Rₙ, as shown in equation (2). Assuming that the current intervals are equally spaced:

$$\begin{matrix}{I}_{n} = \frac{{nI}_{max}}{N} \\ = \frac{- {V}_{GS}}{{\sum }_{i = 0}^{N - n} {R}_{N - i}}\end{matrix} \qquad ( 2 )$$

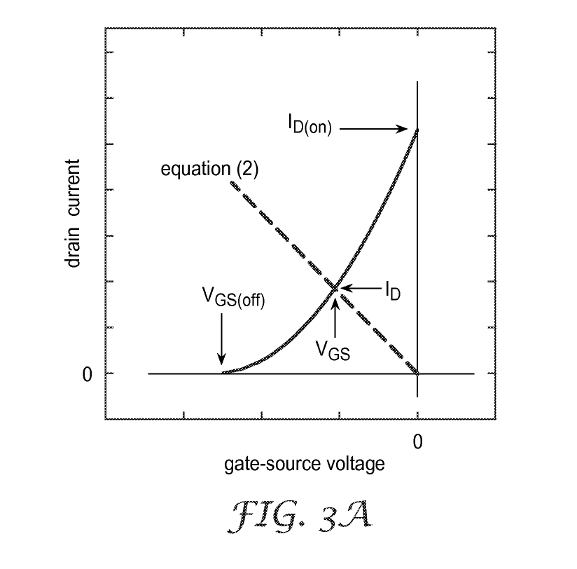

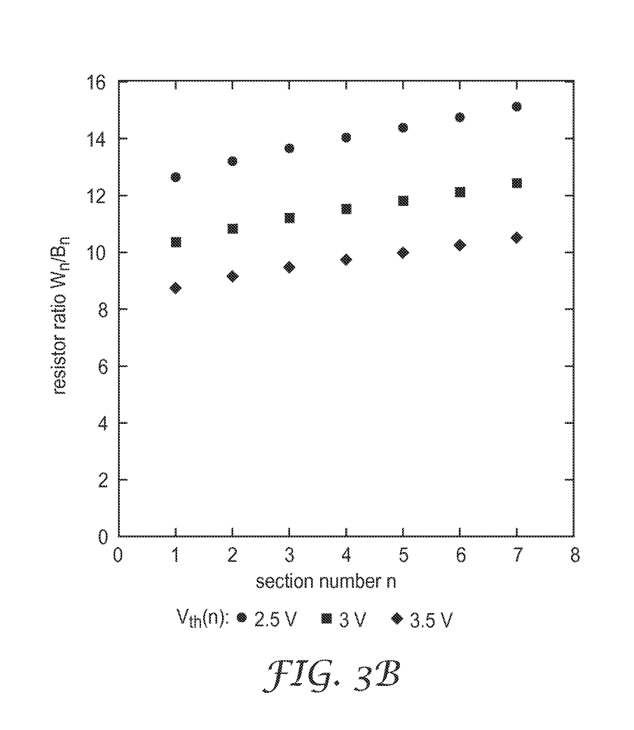

Referring to FIG. 3A that approximates the gate-source voltage versus drain current characteristic for a depletion mode transistor with a parabola:

$${I}_{D} = {I}_{D ( on )} - {( \frac{{V}_{GS}}{{V}_{GS ( off )}} - 1 )}^{2} \qquad ( 3 )$$

defines the parameters I_{D(on)} and V_{GS(off)}. Using these parameters and equation (2) leads to two equations for the section resistances Rₙ:

$$\begin{matrix}{R}_{N} = \frac{- {V}_{GS ( off )}}{{I}_{max}} \{ 1 - \sqrt{\frac{{I}_{max}}{{I}_{D ( on )}}} \} & ( 4 a ) \\ {R}_{n} = \frac{- {V}_{GS ( off )}}{{I}_{max}} \{ \frac{N}{n} - \frac{N}{n + 1} - \sqrt{\frac{{I}_{max}}{{I}_{D ( on )}}} ( \sqrt{\frac{N}{n}} - \sqrt{\frac{N}{n + 1}} ) \} \\ 1 \leq n < N & ( 4 b )\end{matrix}$$

FIG. 2B is another exemplary circuit diagram of a LED transistor ladder driver circuit 200b. The circuit 200B includes a current regulation transistor Q, and for each light section n, a resistor Rₙ and a switch transistor Gₙ (except the highest light section N, which does not include a switch transistor) that are also included in the circuit 200 as illustrated in FIG. 2A. The circuit 200B includes additional resistors R_{dn}, Bₙ, Wₙ, and a transistor Tₙ for each light section n where n<N to control the gate voltage of the switch transistors G.

When section n's current Iₙ leading to a section voltage Vₙ=Lₙ·V_{LED}(Iₙ) is ready to be illuminated, then the rectified voltage Vᵣ must satisfy the following inequality:

Vᵣ>nVₙ1≦n≦N (5)

with Lₙ the number of LED junctions in one section and V_{LED}(Iₙ) the V(I) curve for one LED junction.

For that greater value of Vᵣ=(n+1)Vₙ₊₁ and the already illuminated sections still drawing Iₙ, the gate-source threshold voltage Vₜₕ(n) of transistor Tₙ is approximately given by:

$${V}_{th} ( n ) \approx \frac{{B}_{n}}{{B}_{n} + {W}_{n}} [ ( n + 1 ) {V}_{n + 1} - ( n - 1 ) {V}_{n} ] , \\ where \\ 1 \leq n \leq N - 1 \qquad ( 6 )$$

The approximation is a result of ignoring the voltage drop over G and Q and Q's effective source resistance. The value of Vₜₕ(n) is interpreted as that gate-source voltage value leading to a Tₙ drain current that is sufficient to shut off G. Rearranging Equation (6) gives for the resistor ratio at the switching point Vᵣ=(n+1)Vₙ₊₁:

$$\frac{{W}_{n}}{{B}_{n}} \approx \frac{( n + 1 ) {V}_{n + 1} - ( n - 1 ) {V}_{n} - {V}_{th} ( n )}{{V}_{th} ( n )} \\ 1 \leq n \leq N - 1 \qquad ( 7 )$$

The transistor Tₙ can be an N-channel enhancement type MOSFET. In some embodiments, the transistor Tₙ can be a low power MOSFET, such as a 2N7000 MOSFET. The threshold voltage Vₜₕ is parameterized for 2.5, 3 and 3.5 [V] as guided by the 2N7000 MOSFET datasheet. FIG. 3B illustrates a graph of resistor ratio Wₙ/Bₙ versus section number. FIG. 3B shows a slight ratio increase with higher section number, because the Vₙ value gradually increases for increasing n and thus increasing Iₙ. The graph shows a possible need for fine-tuning the resistor selections for varying Vₜₕ values and increasing section number n.

FIG. 2C illustrates yet another exemplary circuit diagram of a LED transistor ladder driver circuit 200C. The circuit 200C includes a current regulation transistor Q, and for each light section n, a resistor Rₙ and a switch transistor Gₙ (except the highest light section N, which does not include a switch transistor) that are also included in the circuit 200 as illustrated in FIG. 2A. The circuit 200C includes additional resistors R_{dn}, Rₜₙ, R_{bn}, and a transistor Tₙ for each light section n where n<N to control the gate voltage of the switch transistors G. R_{bn} can be a variable resistive element, such as a potentiometer.

Referring back to FIG. 2A, the ladder network has dimming capability with dimmer circuit 220, which provides for activation of only a selected number of light sections of the ladder. This selected number can include only the first section (LS₁), all sections (LS₁ to LS_{N}), or a selection from the first section (LS₁) to a section LSₙ where n<N. The dimmer circuit is configured to control the number of the light sections activated in sequence. The intensity (dimming) is controlled based upon how many light sections are active with the LEDs turned on with a particular intensity selected by the dimmer circuit.

The ladder network also enables color control through use of dimmer circuit 220. The color output collectively by the LEDs is determined by the dimmer controlling which light sections are active, the selected sequence of light sections, and the arrangement of LEDs in the light sections from the first light section to the last light section. As the light sections turn on in sequence, the arrangement of the LEDs determines the output color with colors 1, 2, . . . n correlated to the color of the LEDs in light sections LS₁, LS₂, . . . LSₙ. The output color is also based upon color mixing among active LEDs in the selected sequence of light sections in the ladder.

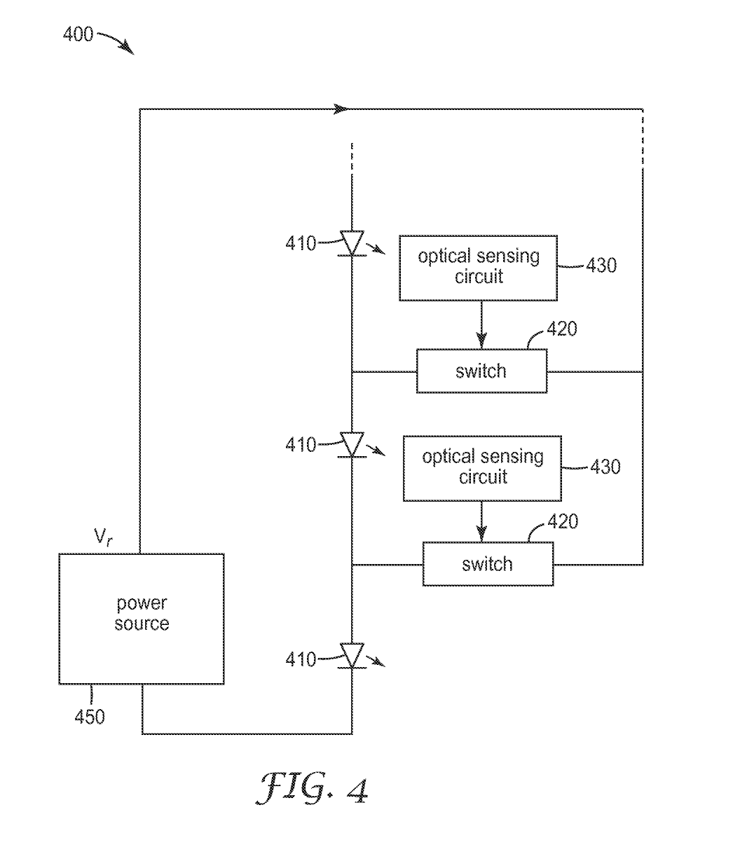

FIG. 4 is a block diagram of an exemplary LED transistor ladder driver with optical sensing 400. In some embodiments, a plurality of light sections are connected in series and configured to connect to a power source, such as an AC power source. The transistor ladder driver 400 includes a power source 450, and for each light section includes an LED device 410, a switch circuit 420, and an optical sensing circuit 430. The light sections are activated in sequence from low to high (i.e., from light section 1 to light section N). The LED device 410 comprises one or more LED junctions, where each LED junction can be implemented with any type of LED of any color emission but with preferably the same current rating. The switch circuit 420 of a light section n is opened or non-conducting when the optical sensing circuit 430 detects the LED illumination from the light section n+1 over a predetermined threshold. In such implementations, the switch circuit 420 of the light section n+1 is closed and the switch circuits of lower light sections i (i≦n) are opened or non-conducting. A LED current flows through the LEDs of the light sections from the first light section to the light section n+1. The switch circuit 420 may include a transistor. The transistor can be a MOSFET, a high power MOSFET, or other components. The optical sensing circuit 430 can detect the illumination of LEDs in a higher adjacent light section (i.e., light section n+1) and open or stop conduction of the switch circuit 420 of the light section (i.e., light section n) to lead to high efficiency of the ladder driver. In some implementations, the optical sensing circuit 430 can include a photodetector, for example, a photodiode, a phototransistor, or the like.

FIG. 5 is an illustrative circuit diagram of an exemplary LED transistor ladder driver with optical sensing 500 for driving a plurality of LEDs connected in series. Circuit 500 includes a series of three (N=3) light sections LS₁, LS₂, and LS₃ connected in series. Each light section n (1≦n≦N) controls Lₙ LED junctions. The first section LS₁ includes LED junctions D₁ depicted as one diode, a resistor R₁, an optical sensing circuit including a resistor R_{c1} and a phototransistor T₁, a transistor Q₁ as a current limiter, and a transistor G₁ as a switch. The second section LS₂ includes LED junctions D₂ depicted as one diode, a resistor R₂, a resistor R_{c2}, a phototransistor T₂, a transistor Q₂ as a current limiter, and a transistor G₂ as a switch. The third section LS₃ includes LED junctions D₃ depicted as one diode and a resistor R₃ and a transistor Q₃ as a current limiter. In some implementations, when a light section n is activated, a large negative gate-source voltage for G transistors in the lower light sections (i.e., light sections i, where i<n) can be obtained such that cut-off is more effective by properly biasing the gate voltage of the G transistors in these lower light sections. In such implementations, the highest light section does not have a G transistor as it typically will not be cut off.

Switch transistors G₁ and G₂ can each be implemented by a depletion mode MOSFET, for example a BSP149 transistor or an IXTA6N50D2 MOSFET. Current limiting transistors Q₁, Q₂, and Q₃ can be implemented by a MOSFET, for example an IXTA6N50D2 MOSFET. The phototransistors T₁ and T₂ can each be implemented by a NTE3031. In the exemplary embodiment illustrated in FIG. 5, the phototransistor T₁ is configured to detect the illumination of the LED junctions D₂ and the phototransistor T₂ is configured to detect the illumination of the LED junctions D₃. The resistances Rₙ are selected such that R_{N}<R_{N-1}< . . . <R₁. The sequence implies that Q₁ will limit light section current I₁ at the lowest value, followed by Q₂ et cetera.

When Q₁ limits current flow to I₁, the continued increase in supply voltage Vᵣ will appear on the drain of Q₁ because all transistors Qₙ, where n>1, will be conducting with low channel resistance. For a certain increase in Vᵣ, the Q₁ drain voltage will have increased so much that D₂ will be ready to illuminate at a maximum current level I₂>I₁. A D₂ incipient illumination could be detected with the phototransistor T₁ to establish cut-off of G₁ leading to high efficiency. This process replicates itself for higher sections with further increasing supply voltage Vᵣ and should be reversible for decreasing Vᵣ. The light sections form a ladder network in order to activate the LEDs in sequence from the first section (LS₁) to the last section (LS₃) in FIG. 5.

The light sections LS₁, LS₂, and LS₃ are connected to a rectifier 518 including an AC power source 519 and a dimmer circuit 520. In FIG. 5, the dimmer circuit 520 is depicted as a TRIAC but can also be based on other line phase cutting electronics. In a practical 120 VAC case there are preferably more than three sections, possibly eight to sixteen sections to bring the section voltage into a range of 10 to 20 volt.

In FIG. 5, only three light sections are shown, but the ladder can be extended to any N light sections with a number of Lₙ LED junctions for each light section n that is consistent with the maximum Vᵣ drive voltage where the total number of LED junctions is given by the summation of

$${\sum }_{n = 1}^{N} {L}_{n} .$$

Also, each light section can contain more than one LED junction. In some cases, each light section contains at least three LED junctions. Multiple LED junctions can be contained in a single LED component or among several LED components.

During extreme line power consumption, an undervoltage situation can occur that may lead to one or more upper LED sections not being illuminated. The other sections however remain illuminated at their rated currents so that undervoltage situations have a limited effect on the total light output.

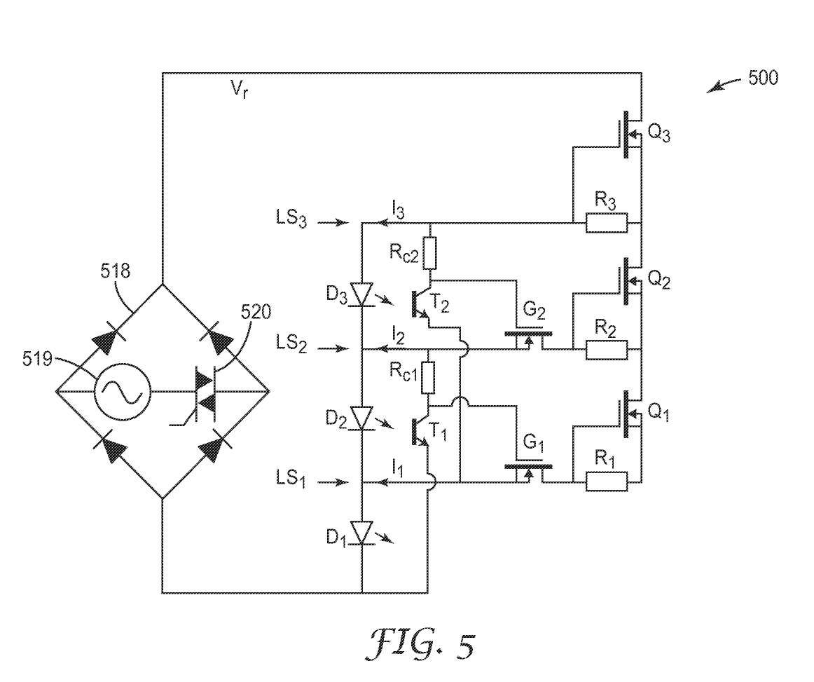

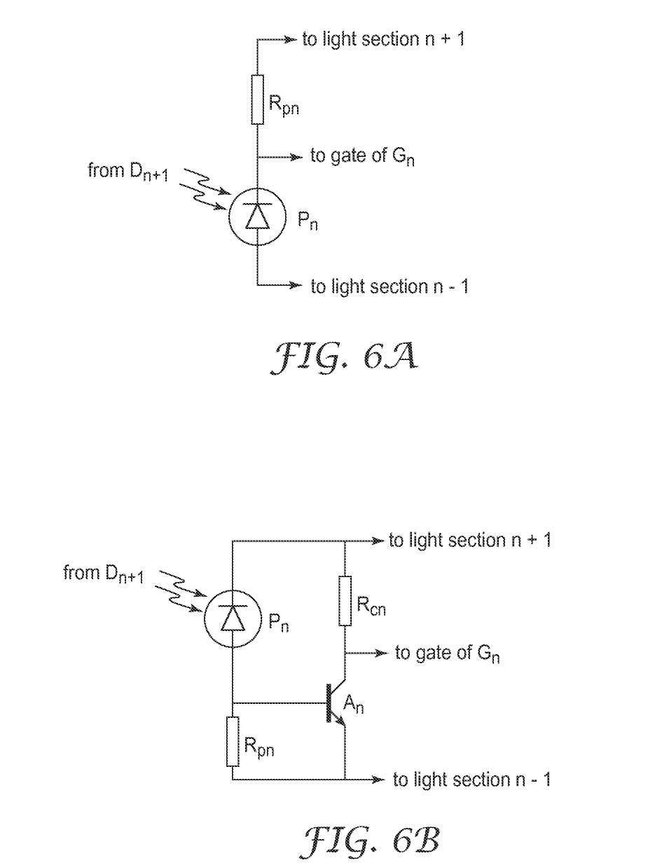

FIGS. 6A and 6B illustrate exemplary optical sensing circuit diagrams for the gate control of the Gₙ of the light section n. In FIG. 6A, a photodiode Pₙ can be used to detect the illumination of the Dₙ₊₁ LED junctions in the light section n+1. A resistor Rₚₙ is also included to provide an optical sensing signal to the Gₙ switch transistor together with the photodiode Pₙ. The Gₙ switch transistor turns off when the optical sensing signal reaches a predetermined threshold. In FIG. 6B, the optical sensing circuit includes the photodiode Pₙ and the resistor Rₚₙ as in FIG. 6A. The optical sensing signal is further amplified by an amplifier Aₙ before the signal is sent to Gₙ. The Gₙ switch transistor turns off when the optical sensing signal reaches a predetermined threshold.

The circuitry leads to outstanding power factor performance. FIG. 7 is a graph illustrating power factor performance of an 11 section LED ladder driver with circuitry similar to the circuit design in FIG. 2B. The power factor PF is evaluated using the general formula for line voltage V and current I shown in equation (8), with T covering an exact integer number of periods and τ arbitrary:

$$PF = \frac{{\int }_{τ}^{τ + T} V \times I d t}{{TV}_{rms} {I}_{rms}} \qquad ( 8 )$$

With the circuitry of the ladder network, power factors of 0.98 or better are easily obtained. For example, the PF value in FIG. 7 is 0.999.

It is also possible to define a single quantity of current total harmonic distortion (THD) to evaluate harmonic performance. Equation (9) defines a THD with the property of 0<THD<1. With I indicating current amplitude and its subscript the harmonic order of the fundamental 60 [Hz] component, the following THD quantity is defined as:

$$\begin{matrix}THD = \frac{\sqrt{{I}_{2}^{2} + {I}_{3}^{2} + {I}_{4}^{2} + …}}{\sqrt{{I}_{1}^{2} + {I}_{2}^{2} + {I}_{3}^{2} + {I}_{4}^{2} + …}} \\ = \frac{\sqrt{{\sum }_{n = 2}^{∞} {I}_{n}^{2}}}{{\sum }_{n = 1}^{∞} {I}_{n}^{2}}\end{matrix} \qquad ( 9 )$$

Table 1 illustrates International Electrotechnical Commission (IEC) compliance mandated in Europe since 2001.

TABLE 1

| | IEC maximum allowed amplitude |
|---|---|
| | normalized on fundamental for |
| harmonic | class C lighting equipment |
| 2^{nd} | 0.02 |
| 3^{rd} | 0.3 × PF |
| 5^{th} | 0.1 |
| 7^{th} | 0.07 |
| 9^{th} | 0.05 |
| 9 < order < 40 | 0.03 |

In general, when THD<0.1, Table 1 compliance is obtained and the THD can be a meaningful guide for current harmonic performance. For a perfectly harmonic voltage Vin equation (8), it can be shown that PF in equation (8) and THD in equation (9) are related by:

$$THD = \sqrt{1 - \frac{{PF}^{2}}{{cos}^{2} {ϕ}_{1}}} \qquad ( 10 )$$

where φ₁ is the phase angle between voltage and fundamental current component.

FIG. 8 is a graph illustrating a current spectrum of a LED ladder driver having harmonic distortion within the IEC limits. The spectrum in FIG. 8 is computed based upon the discrete samples of exactly one period of the LED current waveform in FIG. 7. The spectrum is generated by adding j times the Hilbert transform of the waveform with j²=−1. This is spectrally equivalent to filtering out all negative frequency components and multiplying the positive frequency components by 2. With such computation, the spectral amplitude in FIG. 8 is easily reconciled with the current amplitude in FIG. 7. The THD value of the spectrum in FIG. 8 is 5.1%.

The components of circuits 200 and 500, with or without the LEDs, can be implemented in an integrated circuit. Leads connecting the LED sections enable the use as a driver in solid state lighting devices. Examples of solid state lighting devices are described in U.S. patent application Ser. No. 12/535,203 and filed on Aug. 4, 2009, U.S. patent application Ser. No. 12/960,642 and filed on Dec. 6, 2010, and U.S. patent application Ser. No. 13/019,498 and filed on Feb. 2, 2011, all of which are incorporated herein by reference as if fully set forth.

What is claimed is:

1. A circuit for controlling operation of light emitting diodes (LEDs), comprising:
a plurality of light sections connected in series, the light sections being configured for connection to an AC power source, wherein each light section comprises:
an LED, and
a switch circuit coupled to the LED and configured to activate the LED; and
a current regulating circuit coupled to the plurality of light sections,
wherein at least two light sections are activated in sequence in response to power supplied from the AC power source,
wherein the current regulating circuit is configured to limit a LED current flowing through the plurality of light sections based upon the number of activated light sections.

2. The circuit of claim 1, wherein each light section further comprises a resistive element, wherein the resistance of the resistive element is a function of the peak line current of the circuit and the section number.

3. The circuit of claim 1, wherein the current regulating circuit comprises a transistor.

4. The circuit of claim 1, wherein the switch circuit comprises a transistor.

5. The circuit of claim 4, wherein the switch circuit further comprises a resistive element.

6. The circuit of claim 4, wherein the switch circuit further comprises a variable resistive element.

7. The circuit of claim 1, wherein the switch circuit comprises a MOSFET.

8. The circuit of claim 1, wherein the switch circuit comprises a high power MOSFET and a low power MOSFET.

9. The circuit of claim 1, wherein the current regulating circuit comprises a MOSFET.

10. A circuit for controlling operation of a string of light emitting diodes (LEDs), comprising:
a first section and a second section connected in series, the sections being configured for connection to a power source, wherein each section comprises:
at least one LED;
an optical sensor coupled to the at least one LED and configured to output a signal indicative of the optical output of the at least one LED; and
a switch circuit coupled to the at least one LED,
wherein the switch circuit activates the at least one LED and controls current through the at least one LED,
wherein the first section is activated before the second section in response to power supplied from the power source,
wherein the switch circuit of first section turns off if the signal output by the optical sensor of the second section reaches a predetermined threshold.

11. The circuit of claim 10, wherein the optical sensor comprises a photodetector.

12. The circuit of claim 10, wherein the switch circuit comprises a transistor.

13. The circuit of claim 10, wherein the switch circuit comprises a resistive element.

14. The circuit of claim 10, wherein the switch circuit comprises a MOSFET.
